(19) United States
(12) Patent Application Publication
(10) Pub. No.: US 2018/0340135 A1
(43) Pub. Date: Nov. 29, 2018

(54) FLOOR AND SURFACE DRY-CLEANING COMPOSITION AND METHOD

(71) Applicant: José Germano García Reyes, Santa Catarian Nuevo Leon (MX)

(72) Inventor: José Germano García Reyes, Santa Catarina Nuevo Leon (MX)

(21) Appl. No.: 16/053,751

(22) Filed: Aug. 2, 2018

Related U.S. Application Data
(62) Division of application No. 15/363,397, filed on Nov. 29, 2016.

(30) Foreign Application Priority Data
Dec. 11, 2015 (MX) MX/A/2015/017122

(51) Int. Cl. C11D 3/20; C11D 11/00; C11D 7/44; C11D 3/382; C11D 7/26

(52) U.S. Cl. CPC C11D 3/2065; C11D 11/0023; C11D 7/44; C11D 7/261; C11D 3/382

(57) ABSTRACT

An optimal composition and method to dry-clean floors and surfaces eliminating the need to using water, allowing particle and dust removal in open and closed areas is presented. This invention is comprised of a solid wood waste or sawdust composition combined with lubricant agents and a method for correct usage for dry-cleaning in an easy, controlled and environmentally friendly manner by reducing harmful compounds in the cleaning process.

### CROSS REFERENCE TO RELATED APPLICATIONS

This application is a divisional application of pending U.S. patent Ser. No. 15/384,283, which claims priority to Mexico application number. Mx/a/2015/017122 filed on Dec. 11, 2015. The content of this document and the entire disclosure of publications, patents, and patent documents mentioned herein are incorporated by reference.

### DESCRIPTION

### Purpose of the Invention

Provide dry-cleaning composition and method to speed-up and optimize floor-cleaning processes, capable of removing dust and particles, in an easy, controlled and friendly environmental manner to reduce harmful compositions in the cleaning operation.

### Background

To clean floors, nowadays and by default, we do so with a cloth mop and much water and chemical products. This activity takes up time, the use of much water and sometimes chemicals, which are abrasive with the surface and with the environment. Other times we use the mop or flat mop pushing it causing that dust on the floors and surfaces barely stay on the flat mop or mop and the rest be smeared on the floor causing more dirt on the surface and expense because flat mops or mops are frequently changed. In addition, it is a custom to carry out this process with sawdust mixed with diesel, gasoline or gas, that is, kerosene hydrocarbons, making the cleaning process more expensive.

Taking into consideration the need to make the job easier, taking care of water and avoiding as much as possible the use of different chemicals and hydrocarbons, we thought of this process and product, with this product, sweeping or dry-cleaning collecting all the dust.

Some of the products use sand which scratch the polished floors, with this one no, because it only uses solid wood waste or sawdust plus a lubricant. Other products use wood grounded in hammermills and/or sieve and splinters harm users hands, this one not because it is made from wood waste residue from circular saws or bandsaws from sawmills, carpentry or wood shops.

### DETAILED DESCRIPTION OF THE INVENTION

We now present the composition for dry-cleaning is comprised of:

1% at 50% of solid wood waste or sawdust, and 50% up to 99% PIP of any type of lubricant oily substance preferably glycerin.

Said composition must achieve a uniform structure and composition mixture with the solid wood waste or sawdust, mixed with any type of lubricant, preferably

| | |
|---|---|
| Solid wood waste or sawdust | 90% |
| Glycerin derived from biodiesel process | 10% |

Example of the Composition with Glycerin,

A non-limiting example is established under the following parameters and proportions:

To create the product formula, you must use a unit weight for it, in this case in accordance with the following percentage parameters:

To prepare this product, the lubricant agent must be mixed with the solid wood waste or sawdust in a homogeneous manner in accordance with the parameters, which go from 50% lubricant mixed with 50% solid wood waste, or sawdust up to 1% of lubricant agent mixed with 99% solid wood waste or sawdust.

| | |
|---|---|
| Solid wood waste or sawdust | 90% |
| Glycerin derived from biodiesel process | 10% |

In addition, this invention describes a floor and surface dry-cleaning method comprised of the stages,
i) Distribute a good amount of the composition using a ratio of 0.05 kg of composition/m² of the surface to clean up to 0.3 kg of the composition/m² of the surface to clean where said dry-cleaning composition as previously described is scattered in front of the user from one end of the area over the surface to be cleaned and then
ii) Move the dry-cleaning composition by sweeping over the area to be cleaned and
   1. Sweep with the broom or push brooms in case of irregular surfaces, moving the product with the mentioned tools and at the same time the particles of the composition will capture the dust until the sweeping area or surface to be cleaned is cleaned;
   2. And on smooth or polished surface where the previous process may also be applied, but ideally is to use as a cleaning tool the mop or flat mop, a generous amount of the composition is scattered in front of the tool and is moved by pushing the composition, the composition for its formula will capture the dust and will not will not be spread with the wind and will not cause dust clouds, as a consequence, the area nor the surrounding areas or objects will not get dirty, so finally
   3. In case of wind dusting, often the composition is moved from one end of the surface to be cleaned and with 500 to 800 psi air pressure, which uniformly pushes the composition until it is completely moved over the area to be cleaned.
iii) Remove the composition once used to dispose of it in accordance with the regulations.

1. The cleaning method for floor and surface dry-cleaning, wherein it is comprised of the stages:
i. Use a generous amount of the composition for floor and surface dry-cleaning comprised of at least 50% weight/weight to 1% weight/weight of solid wood waste or sawdust and 50% weight/weight to 1% of oily lubricant, where said composition is manually or automatically scattered over part of the surface to be cleaned at a ratio of 0.05 kg of the composition/m² of the surface to be cleaned up to 0.3 kg of the composition/m² of the surface to be cleaned to then
ii. Scatter the composition for dry-cleaning by sweeping with any means all the area to be cleaned,
iii. Remove the composition once it has been used for final disposition according to the regulation.

2. The cleaning method for floor and surface dry-cleaning according to claim 1, wherein in stage i) a composition of 90% weight/weight of solid wood waste or sawdust preferably pine is used and 10% weight/weight glycerin recovered from the biodiesel generation process.

3. The cleaning method for floor and surface dry-cleaning, according to claim 1, wherein in stage ii, in the case of irregular and smooth or polished surfaces, it is carried out through broom or push broom sweeping; starting from the edge of the area to be cleaned, then the composition is swept throughout the area; the particles of the composition will capture the dust until the whole seeping area or surface is cleaned;

4. The cleaning method for floor and surface dry-cleaning according to claim 1, wherein in stage ii) in the smooth and polished surface a cleaning tool such as mop or flat mop are used thus moving the composition whose formula will capture dust and will not scatter it with the wind nor cause dust clouds, therefore, it will not tarnish the surrounding areas or objects.

5. The cleaning method for floor and surface dry-cleaning according to claim 17, wherein in stage ii) when cleaning with compressed air followed by moving the composition from one end of the surface to be cleaned and with 500 to 800 psi pressured air will uniformly push the composition until this movement over the area to be cleaned is finished.
